(19) United States
(12) Patent Application Publication
(10) Pub. No.: US 2025/0345871 A1
(43) Pub. Date: Nov. 13, 2025

(54) ELECTRICAL DISCHARGE MACHINING EQUIPMENT AND METHOD WITH EQUIDISTANTLY TRIGGERING DISCHARGE

(71) Applicant: NATIONAL TAIWAN NORMAL UNIVERSITY, Taipei (TW)

(72) Inventors: Shun-Tong Chen, Taipei (TW); Yi-Che Chung, Taipei (TW)

(21) Appl. No.: 19/010,862

(22) Filed: Jan. 6, 2025

(30) Foreign Application Priority Data
May 9, 2024 (TW) 113117195

(51) Int. Cl. B23H 7/20; B23H 7/26

(52) U.S. Cl. CPC B23H 7/20; B23H 7/26

(57) ABSTRACT

An electrical discharge machining equipment with equidistantly triggering discharge includes an electrode, a position processing unit, a discharge circuit module, and a controller. The electrode moves along a process path to process a work piece. The position processing unit generates a processing signal when the moving distance matches up with the discharge triggering distance, and generates a plurality of processing signals according to the process path, the discharge triggering distance and the moving distance. The discharge circuit module includes a first discharge for generating a first discharge current and a second discharge circuit for generating a second discharge current. The controller controls the discharge circuit module to alternatively provide the first discharge current and the second discharge current to the electrode during the period of the discharging signal of the processing signal.

### BACKGROUND OF THE INVENTION

### 1. Field of the Invention

The present invention relates to the field of electrical discharge machining, and more particularly, relates to an electrical discharge machining equipment and method with equidistantly triggering discharge.

### 2. Description of the Prior Art

In recent years, with the advancement of technologies in the fields of semiconductors, electronics, and mechanical technologies have driven products toward miniaturization and precision. In fields such as aerospace, automotive, medical, and electronics, micro-sized products are often manufactured using high-precision molds. Generally, materials chosen for high-precision molds are of high hardness and strength, such as SKD-11. Due to the high mechanical strength and complex design structures of high-precision molds, they are typically processed using CNC wire-cut electrical discharge machining (EDM) machines.

Generally, during the electrical discharge machining process, the discharge energy of the electrode is continuously applied for a fixed duration. However, when the machining path of the electrode shifts from linear to non-linear, the path vector changes from single-axis to dual-axis movement. This indicates that the feed rate of the electrode is lower than single-axis movement, which may lead to overly dense or overly sparse discharge points, cause deviations in the cutting path at the corners of the work piece, resulting in either over-cutting or under-cutting errors, as well as errors in the geometric shape and accuracy of the work piece, thereby reducing machining precision and efficiency.

Therefore, it is necessary to provide a new electrical discharge machining equipment to solve the problems of the prior art.

### SUMMARY OF THE INVENTION

Therefore, the present invention provides an electrical discharge machining equipment with equidistantly triggering discharge. In one embodiment of the present invention, the electrical discharge machining equipment with equidistantly triggering discharge includes an electrode, a position processing unit, a discharge circuit module, and a controller.

The electrode is configured to move along a process path to process a work piece. The position processing unit stores a discharge triggering distance and detects a moving distance of the electrode. The position processing unit generates a processing signal when the moving distance matches up with the discharge triggering distance, and generates a plurality of processing signals according to the process path, the discharge triggering distance and the moving distance. Wherein, the processing signal includes a discharge signal. The discharge circuit module is electrically connected to the electrode. The discharge circuit module includes a first discharge circuit for generating a first discharge current and a second discharge circuit for generating a second discharge current. The controller is connected to the electrode, the position processing unit and the discharge circuit module. The controller is configured to control the discharge circuit module to provide discharge current according to the plurality of the processing signals, and control the discharge circuit module to alternatively provide the first discharge current and the second discharge current to the electrode during the period of the discharging signal of the processing signal.

Wherein, the electrode moves at a feed rate. The position processing unit calculates a processing time length corresponding to the processing signal according to the feed rate and the discharge triggering distance, and the discharge signal corresponds to a discharge time length which is between ½ and ⅓ of the processing time length.

Wherein, the processing signal includes a plurality of discharge cycles, and each discharge cycle includes the discharge signal and a rest signal.

Wherein, the controller pre-stores a voltage threshold. The controller is configured to measure a gap voltage value between the electrode and the work piece. When the gap voltage value is larger than the voltage threshold, the controller controls the electrode to move in a direction opposite to the machining direction.

Wherein, the electrical discharge machining equipment further includes an input unit connected to the position processing unit and the controller. The input unit is configured to input the discharge triggering distance and the feed rate.

Wherein, the process path is a non-linear machining path.

Wherein, the position processing unit is a Position Synchronized Output (PSO) unit.

Wherein, the controller is a Field Programmable Gate Array (FPGA).

In one embodiment of the present invention, an electrical discharge machining method with equidistantly triggering discharge includes the following steps of: the electrode moving along a process path corresponding to the work piece; the position processing unit detecting a moving distance of the electrode; the position processing unit generating a processing signal when the moving distance matches up with the discharge triggering distance, and generating a plurality of processing signals according to the process path, the discharge triggering distance and the moving distance, wherein the processing signal includes a discharge signal; and the controller controlling the discharge circuit module according to the processing signal to alternatively provide the first discharge current and the second discharge current to the electrode during the period of the discharging signal of the processing signal to process the work piece.

Wherein, the electrical discharge machining method with equidistantly triggering discharge further includes the following steps of: the controller measuring a gap voltage value between the electrode and the work piece; and the controller controlling the electrode to move in a direction opposite to the machining direction when the gap voltage value is larger than the voltage threshold.

In summary, the electrical discharge machining equipment with equidistantly triggering discharge of the invention can generate the processing signal with equidistant trigger discharge through the position processing unit, and can trigger pulse energy with equidistantly triggering discharge to discharge through the discharge circuit module controlled by the controller. This ensures that the electrode has an equal distribution of discharge pulse points at each small distance along the corner of the work piece, thereby preventing machining errors caused by overly concentrated or dispersed discharge energy and improving machining accuracy and efficiency. In addition, the electrical discharge machining equipment E with equidistantly triggering discharge of the invention also includes a short circuit detection function to improve machining efficiency.

### BRIEF DESCRIPTION OF THE APPENDED DRAWINGS

FIG. 1 is a functional block diagram illustrating an electrical discharge machining equipment with equidistantly triggering discharge according to an embodiment of the present invention.

FIG. 2 is a timing diagram illustrating the processing signal and the discharge current according to the embodiment of the present invention.

FIG. 3 is a simplified diagram illustrating the electrode machining the work piece according to the embodiment of the present invention.

FIG. 4 is a timing diagram illustrating the processing signal and the discharge current according to an embodiment of the present invention.

FIG. 5 is a flow chart illustrating an electrical discharge machining method with equidistantly triggering discharge according to an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

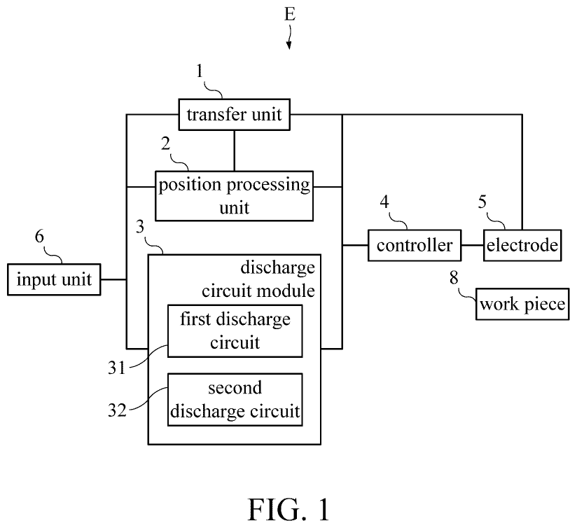

Please refer to FIG. 1. FIG. 1 is a functional block diagram illustrating an electrical discharge machining equipment E with equidistantly triggering discharge according to an embodiment of the present invention. As shown in FIG. 1, in this specific embodiment, the electrical discharge machining equipment E includes a transfer unit 1, a position processing unit 2, a discharge circuit module 3, a controller 4, and an electrode 5. The transfer unit 1 is connected to the position processing unit 2, the controller 4, and the electrode 5. The position processing unit 2 is connected to the controller 4. The discharge circuit module 3 is connected with the controller 4 and the electrode 5. The controller 4 is connected to the electrode 5. The transfer unit 1 is configured to control the movement of the electrode 5 and can transmit signals and data bidirectionally with the position processing unit 2 and the controller 4. The position processing unit 2 is configured to generate and transmit a processing signal to the controller 4. The discharge circuit module 3 is configured to output a discharge current. The controller 4 is configured to control the electrode 5 to process the work piece 8 according to the signals and parameters generated by the transfer unit 1, position processing unit 2, and discharge circuit module 3.

In this specific embodiment, the transfer unit 1 controls the electrode 5 to move along a process path to process the work piece 8. In practice, the transfer unit 1 can be a machining platform of a Computer Numerical Control (CNC) machine tool. The machining platform can support the work piece 8 and move along multiple axes (e.g., X-axis, Y-axis, Z-axis, and a rotatable U-axis). The electrode 5 can be fixed at a machining position. The machining path can be pre-programmed or imported into the CNC machine tool and can include at least one of a straight line, arc, or curve. The transfer unit 1 can move the work piece 8 according to the process path, allowing the electrode 5 can move along the process path to process the work piece 8. Additionally, the transfer unit 1 can store a feed rate to control the moving speed of the work piece 8. In another embodiment, the transfer unit can also carry the electrode and control the electrode to move along the process path at a stored feed rate and control the work piece to be fixed in the machining position. As the transfer unit 1 controls the movement of either the electrode 5 or the work piece 8, a moving distance is generated.

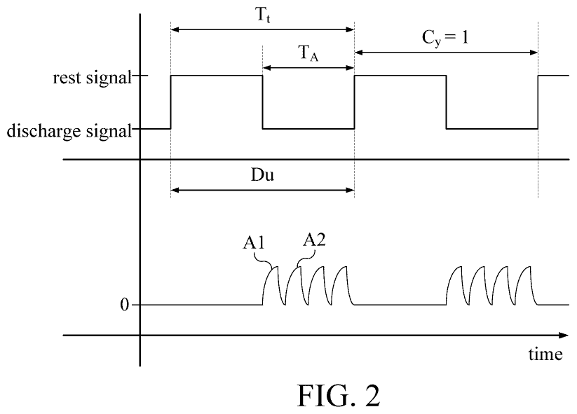

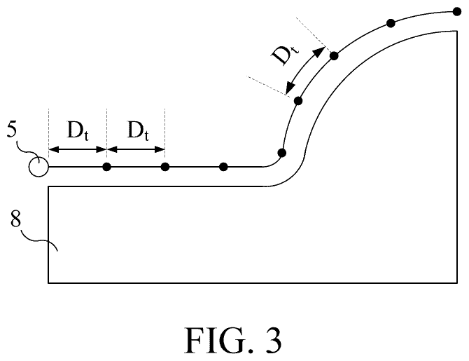

Please refer to FIG. 1 to FIG. 3. FIG. 2 is a timing diagram illustrating the processing signal and the discharge current according to the embodiment of the present invention. FIG. 3 is a simplified diagram illustrating the electrode 5 machining the work piece 8 according to the embodiment of the present invention. As shown in FIG. 1 to FIG. 3, in this specific embodiment, the position processing unit 2 stores a discharge triggering distance and detects the moving distance of the electrode 1. When the moving distance matches up with the discharge triggering distance, the position processing unit 2 generates a processing signal. In practice, the discharge triggering distance is used as the basis for controlling the electrode 5 to perform discharge and can be set according to design, requirements, or the machining accuracy of the CNC. When the position processing unit 2 detects that the moving distance matches up with the discharge triggering distance, the position processing unit 2 generates and sends the processing signal to the controller 4. It should be noted that the position processing unit 2 generates the processing signal each time the moving distance matches up with the discharge triggering distance. In practical applications, the position processing unit 2 can detect the moving distance by accumulating distance values. For example, as shown in FIG. 3, when the discharge triggering distance is set to 2 μm, and the total moving distance of the transfer unit 1 is 10 μm, the position processing unit 2 will generate 5 processing signals (at 2 μm, 4 μm, 6 μm, 8 μm, and 10 μm, respectively). In other words, the position processing unit 2 can generate multiple processing signals according to the process path length, discharge trigger distance, and moving distance, and the position processing unit 2 equidistantly triggers the electrode 5 to perform discharge machining.

As shown in FIG. 2, in this specific embodiment, the processing signal includes a discharge signal and a rest signal. The processing signal has a processing time length, and the discharge signal has a discharge time length. The position processing unit 2 is configured to calculate the processing time length corresponding to the processing signal according to the feed rate of the transfer unit 1 and the discharge triggering distance. The formula is as follows:

$${T}_{t} = \frac{{D}_{u}}{{C}_{y}} = \frac{{D}_{t}}{F \times {C}_{y}}$$

$${T}_{A} = \frac{{T}_{t}}{2} = \frac{{D}_{t}}{2 \times F \times {C}_{y}}$$

Where Tt is the processing time length, Du is the time required for moving the discharge triggering distance, Cy is the triggering count, Dt is the discharge triggering distance, F is the feed rate, and T_{A} is the discharge time length.

In practice, the position processing unit 2 can first calculate the time length required to move the discharge triggering distance according to the feed rate and discharge triggering distance, and convert distance into time to determine the timing for each processing signal emitted by the position processing unit 2. Furthermore, the position processing unit 2 can generate the discharge signals and the rest signals through alternating triggers and switching off. The number of triggers refers to the number of times the position processing unit 2 switches between triggering and switching off. When the number of triggers is 1, it indicates that there is only one discharge signal and one rest signal in the processing signal. At this time, the processing time length is equal to the time length required to move the discharge triggering distance.

Furthermore, in this specific embodiment, the discharge time length is half of the processing time length. That is to say, the time length of the discharge signal and the time length of the rest signal are equal. In practice, the relationship between the discharge time length and processing time length is not limited hereto, the discharge time length can be between ½ and ⅓ of the processing time length and can be determined according to design or requirement.

As shown in FIG. 1 and FIG. 2, in this specific embodiment, the discharge circuit module 3 includes a first discharge circuit 31 and a second discharge circuit 32. The first discharge circuit 31 includes a first capacitance and is configured for generating a first discharge current A1. The second discharge circuit 32 includes a second capacitance and is configured for generating a second discharge current A2. In practice, the discharge circuit module 3 can include multiple transistors and the transistors control the first discharge circuit 31 and the second discharge circuit 32 to alternatively discharge. Additionally, the capacitance values of the first capacitance and the capacitance values of the second capacitance can be the same. Therefore, the discharge energy of the first discharge current A1 and second discharge current A2 can be identical.

In this specific embodiment, the controller 4 controls the discharge circuit module 3 to provide discharge current according to the processing signal generated by the position processing unit 2 and controls the discharge circuit module 3 to alternatively provide the first discharge current and the second discharge current to the electrode 5 during the period of the discharging signal of the processing signal. In practice, the controller 4 determines the timing and the discharge time length of the discharge signal in the processing signal generated by the position processing unit 2, and then controls multiple transistors of the discharge circuit module 3 to alternate discharges the first discharge circuit 31 and the second discharge circuit 32. When the controller 4 controls the first discharge circuit 31 to discharge, the controller 4 also controls the second discharge circuit 32 to charge through transistors. Then, the controller 4 controls the second discharge circuit 32 to discharge while simultaneously controlling the first discharge circuit 31 to charge through the transistors. Consequently, the electrode 5 can continuously receives the first discharge current and the second discharge current to process the work piece 8. The formula for the controller 4 to control the discharge of the discharge circuit module 3 is as follows:

$${N}_{dis} = {T}_{A} \times {f}_{dis}$$

Where, N_{dis} is the number of discharges, T_{A} is the discharge time length f_{dis} is the discharge frequency. As shown in FIG. 2, each peak of the discharge current represents a charging/discharging waveform, and all peaks of the discharge current correspond to alternating waveforms of the first discharge current and the second discharge current. The discharge frequency of the discharge circuit module 3 can be determined according to design or requirements.

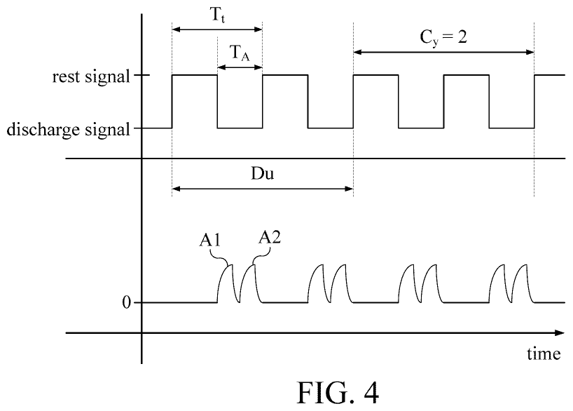

The processing signal generated by the position processing unit and the discharge current of the discharge circuit module can be in other forms in addition to the specific embodiment mentioned above. Please refer to FIG. 4. FIG. 4 is a timing diagram illustrating the processing signal and the discharge current according to an embodiment of the present invention. In this embodiment, as shown in FIG. 4, in the time corresponding to each discharge triggering distance (Dt), the triggering count (Cy) of the position processing unit 2 is 2 times, indicating that the processing signal includes two discharge signals and rest signals. In other words, during the period of the movement of the discharge triggering distance when the transfer unit 1 controls the movement of electrode 5 or the processing platform, the position processing unit 2 generates two processing signals, and each processing time length (Tt) and discharge time length (T_{A}) is half of the original. Although the discharge time length is reduced, the total discharge time for each discharge triggering distance remains the same. Therefore, the total discharge energy is the same. In practice, the triggering count (Cy) is not limited to 1 or 2 times, and can be determined according to the design or requirements.

The electrical discharge machining equipment E with equidistantly triggering discharge of the invention can be applied to non-linear machining paths. In practice, the position processing unit 2 can be a Position Synchronized Output (PSO) unit, and the controller 4 can be a Field Programmable Gate Array (FPGA). During actual operation, the position processing unit 2 first detects the actual moving distance of the electrode 5 or the machining platform controlled by the transfer unit 1. When the moving distance matches the discharge triggering distance, the position processing unit 2 generates the processing signals according to the triggering count. Next, the controller 4 controls the discharge time and the number of discharges of the discharge circuit module 3 according to the discharge time length of the discharge signal in the processing signal, and alternately provides the first discharge current and the second discharge current to the electrode 5 to process a work piece 8. Therefore, the electrical discharge machining equipment E with equidistantly triggering discharge of the invention can generate the processing signal with equidistant trigger discharge through the position processing unit, and can trigger pulse energy with equidistantly triggering discharge to discharge through the discharge circuit module controlled by the controller. This ensures that the electrode has an equal distribution of discharge pulse points at each small distance along the corner of the work piece, thereby preventing machining errors caused by overly concentrated or dispersed discharge energy and improving machining accuracy and efficiency.

Please refer again to FIG. 1. In this embodiment, the controller 4 pre-stores a voltage threshold and measures a gap voltage value between the electrode 5 and the work piece 8. When the gap voltage value is larger than the voltage threshold, the controller 4 controls the electrode 5 to move in a direction opposite to the machining direction. In practice, the electrode 5 and the work piece 8 are respectively connected to the positive and negative terminals of the power supply. Therefore, during the machining process, the controller 4 can measure the gap voltage value between the electrode 5 and the work piece 8. When the gap voltage value is larger than the voltage threshold, it indicates that the feed rate is too fast of the electrode 5 or work piece 8, or the discharge short circuit is caused by the accumulation of discharge debris. At this time, the controller 4 will control transfer unit to drive the electrode 5 or the work piece 8 to move in a direction opposite to the machining direction (i.e., retracting movement). Next, once the gap voltage value is less than the voltage threshold or the discharge debris is cleared, the controller 4 resumes controlling the transfer unit 1 and providing discharge current to the electrode 5 according to the processing signal generated by the position processing unit 2 and the discharge circuit module 3. Therefore, the electrical discharge machining equipment E with equidistantly triggering discharge of the invention also includes a short circuit detection function to improve machining efficiency.

In addition, in this embodiment, the discharge machining equipment E with equidistantly triggering discharge can further includes an input unit 6 connected to the transfer unit 1, position processing unit 2, and discharge circuit module 3. The input unit 6 is used to input process parameters. In practice, the input unit 6 can be the human-machine interface of a CNC machine tool. The input unit 6 allows input of the process path, the discharge triggering distance(Dt), the triggering count(Cy), the feed rate(F), the ratio of discharge time length to processing time length, he discharge frequency(fdis), and other parameters mentioned above.

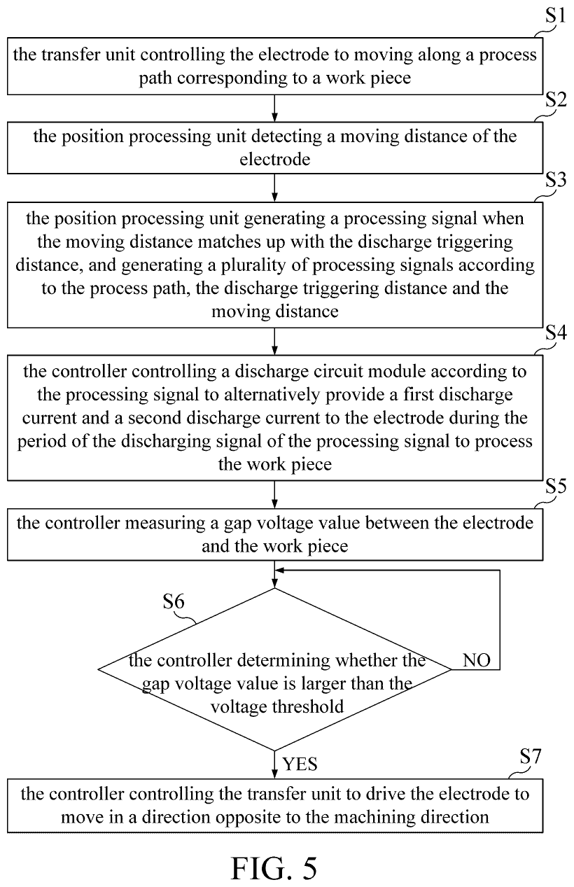

Please refer to FIG. 5. FIG. 5 is a flow chart illustrating an electrical discharge machining method with equidistantly triggering discharge according to an embodiment of the present invention. The steps shown in FIG. 5 can be performed by the he electrical discharge machining equipment E with equidistantly triggering discharge of FIG. 1. As shown in FIG. 1 and FIG. 5, the electrical discharge machining method with equidistantly triggering discharge includes the following steps of: Step S1: the transfer unit 1 controlling the electrode 5 to moving along a process path corresponding to a work piece 8; Step S2: the position processing unit 2 detecting a moving distance of the electrode 5; Step S3: the position processing unit 2 generating a processing signal when the moving distance matches up with the discharge triggering distance, and generating a plurality of processing signals according to the process path, the discharge triggering distance and the moving distance; Step S4: the controller 4 controlling a discharge circuit module 3 according to the processing signal to alternatively provide a first discharge current and a second discharge current to the electrode 5 during the period of the discharging signal of the processing signal to process the work piece 8; Step S5: the controller 4 measuring a gap voltage value between the electrode 5 and the work piece 8; Step S6: the controller 4 determining whether the gap voltage value is larger than the voltage threshold; If the determination result is yes, proceed to Step S7: the controller 4 controlling the transfer unit 1 to drive the electrode 5 to move in a direction opposite to the machining direction; If the determination result is no, return to Step S6.

In summary, the electrical discharge machining equipment with equidistantly triggering discharge of the invention can generate the processing signal with equidistant trigger discharge through the position processing unit, and can trigger pulse energy with equidistantly triggering discharge to discharge through the discharge circuit module controlled by the controller. This ensures that the electrode has an equal distribution of discharge pulse points at each small distance along the corner of the work piece, thereby preventing machining errors caused by overly concentrated or dispersed discharge energy and improving machining accuracy and efficiency. In addition, the electrical discharge machining equipment E with equidistantly triggering discharge of the invention also includes a short circuit detection function to improve machining efficiency.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An electrical discharge machining equipment with equidistantly triggering discharge, comprising:
an electrode, configured to move along a process path to process a work piece;
a position processing unit, configured to store a discharge triggering distance and detect a moving distance of the electrode, the position processing unit being configured to generate a processing signal when the moving distance matches up with the discharge triggering distance, and generate a plurality of processing signals according to the process path, the discharge triggering distance and the moving distance, wherein the processing signal comprises a discharge signal;
a discharge circuit module, electrically connected to the electrode, the discharge circuit module comprising a first discharge circuit and a second discharge circuit, the first discharge circuit comprising a first capacitance and being configured for generating a first discharge current, the second discharge circuit comprising a second capacitance and being configured for generating a second discharge current; and
a controller, connected to the electrode, the position processing unit and the discharge circuit module, the controller being configured to control the discharge circuit module to provide discharge current according to the plurality of the processing signals, and control the discharge circuit module to alternatively provide the first discharge current and the second discharge current to the electrode during the period of the discharging signal of the processing signal.

2. The electrical discharge machining equipment with equidistantly triggering discharge of claim 1, wherein the electrode moves at a feed rate, the position processing unit calculates a processing time length corresponding to the processing signal according to the feed rate and the discharge triggering distance, and the discharge signal corresponds to a discharge time length which is between ½ and ⅓ of the processing time length.

3. The electrical discharge machining equipment with equidistantly triggering discharge of claim 1, wherein the processing signal comprises a plurality of discharge cycles, and each discharge cycle comprises the discharge signal and a rest signal.

4. The electrical discharge machining equipment with equidistantly triggering discharge of claim 1, wherein the controller pre-stores a voltage threshold, and the controller is configured to measure a gap voltage value between the electrode and the work piece, and control the electrode to move in a direction opposite to the machining direction when the gap voltage value is larger than the voltage threshold.

5. The electrical discharge machining equipment with equidistantly triggering discharge of claim 2, further comprising an input unit connected to the position processing unit and the controller, wherein the input unit is configured to input the discharge triggering distance and the feed rate.

6. The electrical discharge machining equipment with equidistantly triggering discharge of claim 1, wherein the process path is a non-linear machining path.

7. The electrical discharge machining equipment with equidistantly triggering discharge of claim 1, wherein the position processing unit is a Position Synchronized Output (PSO) unit.

8. The electrical discharge machining equipment with equidistantly triggering discharge of claim 1, wherein the controller is a Field Programmable Gate Array (FPGA).

9. An electrical discharge machining method with equidistantly triggering discharge, comprising the following steps of:
an electrode moving along a process path corresponding to a work piece;
a position processing unit detecting a moving distance of the electrode;
the position processing unit generating a processing signal when the moving distance matches up with the discharge triggering distance, and generating a plurality of processing signals according to the process path, the discharge triggering distance and the moving distance, wherein the processing signal comprises a discharge signal; and
a controller controlling a discharge circuit module according to the processing signal to alternatively provide a first discharge current and a second discharge current to the electrode during the period of the discharging signal of the processing signal to process the work piece.

10. The electrical discharge machining method with equidistantly triggering discharge of claim 9, further comprising the following steps of:
the controller measuring a gap voltage value between the electrode and the work piece; and
the controller controlling the electrode to move in a direction opposite to the machining direction when the gap voltage value is larger than a voltage threshold.
